(19) United States
(12) Patent Application Publication
(10) Pub. No.: US 2026/0309503 A1
(43) Pub. Date: Oct. 8, 2026

(54) NAVIGATION DEVICE, NAVIGATION SYSTEM, NAVIGATION METHOD, AND NAVIGATION PROGRAM

(71) Applicant: Furuno Electric Co., Ltd., Nishinomiya-City (JP)

(72) Inventors: Kenta OGAWA, Amagasaki (JP); Mathieu JACQUINOT, Labenne (FR)

(73) Assignee: Furuno Electric Co., Ltd., Nishinomiya-City (JP)

(21) Appl. No.: 19/678,534

(22) Filed: May 15, 2026

Related U.S. Application Data
(63) Continuation of application No. PCT/JP2023/044289, filed on Dec. 11, 2023.

(51) Int. Cl. G01C 21/20; B63B 49/00

(52) U.S. Cl. CPC G01C 21/203; B63B 49/00

(57) ABSTRACT

The navigation device is provided with processing circuitry. The processing circuitry acquires a recommended route connecting two or more waypoints on a chart. Further, the processing circuitry receives a start point and an end point to generate an optimal route for a ship. Furthermore, the processing circuitry determines a cost associated with a plurality of routes and a cost associated with the recommended route. Finally, the processing circuitry generates the optimal route between the start point and the end point based on the cost of the plurality of routes and the cost of recommended route.

### CROSS-REFERENCE TO RELATED APPLICATION

This application is a continuation application of PCT International Application No. PCT/JP2023/044289, which was filed on Dec. 11, 2023, the entire disclosure of which is hereby incorporated by reference.

### TECHNICAL FIELD

The present invention relates to a technique for estimating a specific route for a navigation of a ship.

### BACKGROUND

There is a conventional technology that receives a user input corresponding to a route request from a user. Further, the conventional technology generates a route by connecting a position of a ship and a destination endpoint based on the user input.

### SUMMARY

It is to be noted that, currently, methods for searching a route for a ship using map data, satellite data, weather data are known. Generally, at least one of the map data, the satellite data, and the weather data are analyzed. Further, the route connecting a source location and a destination location is generated based on the analysis of the data. However, it may happen that the route generated based on the analysis of data is a short route, but may not be a route that a user navigating in the area could take. Further, the conventional methods of route searching still requires a user-interaction.

However, an optimal route for a ship may not be generated with good accuracy by a conventional method.

Therefore, the purpose of the present invention is to generate the optimal route with high accuracy for the navigation of the ship.

The navigation device of this invention is provided with processing circuitry. The processing circuitry acquires a recommended route connecting two or more waypoints on a chart. Further, the processing circuitry receives a start point and an end point to generate an optimal route for the ship. Furthermore, the processing circuitry determines a cost associated with a plurality of routes and a cost associated with the recommended route. The cost associated with the recommended route is relatively less than the cost associated with other routes from the plurality of routes. Finally, the processing circuitry generates the optimal route between the start point and the end point based on the cost associated with the plurality of routes and the cost associated with the recommended route.

In this configuration, the optimal route is generated using a shortest path search technique.

In this configuration, the shortest path search technique is one of a Dijkstra's technique, a bidirectional Dijkstra's technique, an A* technique, a bellman-ford technique, and an ant colony optimization technique.

In the navigation device of the present invention, the processing circuitry may generate the plurality of routes connecting the start point and the end point using a plurality of waypoints on the chart. Each route from the plurality of routes include at least one of a first subset of routes and a second subset of routes. The first subset of routes comprise at least a portion of the recommended route and the second subset of routes comprises routes excluding the recommended route.

In the navigation device of the present invention, the processing circuitry may determine a cost associated with each route of the first subset of routes by utilizing a first technique and a cost associated with each route of the second subset of routes by utilizing a second technique.

In this configuration, the first technique comprises a summation of a cost of the two or more waypoints associated with the recommended route. The second technique comprises a summation of a cost multiple waypoints excluding the recommended route.

In the navigation device of the present invention, the processing circuitry may determine the cost between two waypoints in the recommended route based on multiplying a distance between the two waypoints by an arbitrary value less than 1.

In the navigation device of the present invention, the processing circuitry determine the cost between two waypoints excluding the recommended route based on multiplying a distance between the two waypoints by an arbitrary value greater than 1.

In the navigation device of the present invention, the processing circuitry may compare the cost of each route from the plurality of routes connecting the start point and the end point. The optimal route is generated based on the comparison of the cost of each route.

In the navigation device of the present invention, the processing circuitry may apply a smoothing technique on the optimal route except the portion of the recommended route.

In the navigation device of the present invention, the processing circuitry may determine a midpoint between the two waypoints of the recommended route, when the distance between the two waypoints is greater than a predetermined threshold.

In this configuration, the processing circuitry may be acquired from one of a route database and an input from a user.

In the navigation device of the present invention, the processing circuitry may combine data associated with the recommended route database and vertex data associated with a routing database to generate an overlapped database comprising the recommended route overlapped on the vertex data.

In the navigation device of the present invention, a display may display the optimal route to the user.

In this configuration, the start point corresponds to a current location of the ship and the end point is received based on a user input.

The navigation system of the present invention is provided with the navigation device described above and a control unit. Based on the cost of each route from the plurality of routes, connecting the start point and the end point, the control unit generates the optimal route for the ship.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a functional block diagram of a navigation device according to an embodiment of the present invention;

FIG. 2 is a block diagram of a route generation unit according to an embodiment of the present invention;

FIG. 3 is a functional block diagram of a navigation system according to an embodiment of the present invention;

FIG. 4(A) is a block diagram of an overlapping unit according to an embodiment of the present invention;

FIG. 4(B) shows an overlapped database according to an embodiment of the present invention;

FIG. 4(C) shows determination of a midpoint on a recommended route according to an

FIG. 4(D) shows the receiving of a start point and an end point of a ship according to an embodiment of the present invention;

FIG. 4(E) shows applying smoothing on the optimal route according to an embodiment of the present invention;

FIG. 4(F) shows an example of generation of the optimal route according to an embodiment of the present invention;

FIG. 5 shows a graph used for generation of the optimal route according to an embodiment of the present invention;

FIG. 6(A) shows determination of a cost of each route according to an embodiment of the present invention; and

FIG. 6(B) shows determination of a cost of each route according to an embodiment of the present invention; and

FIG. 6(C) shows determination of a cost of each route according to an embodiment of the present invention; and

FIG. 7 is a flow chart showing an example of the navigation device according to an embodiment of the present invention.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

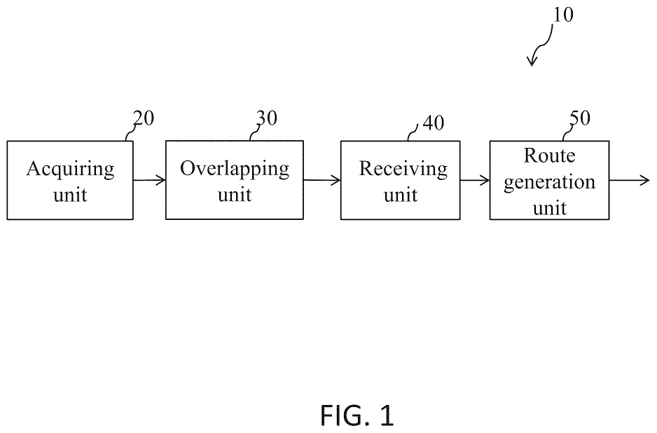

The navigation technology of the embodiment of the present invention will be described with reference to the figures. FIG. 1 is a functional block diagram of a navigation device according to an embodiment of the present invention.

### Schematic Configuration of the Navigation Device 10

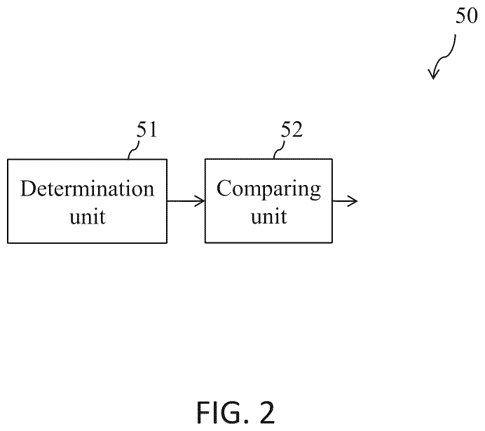

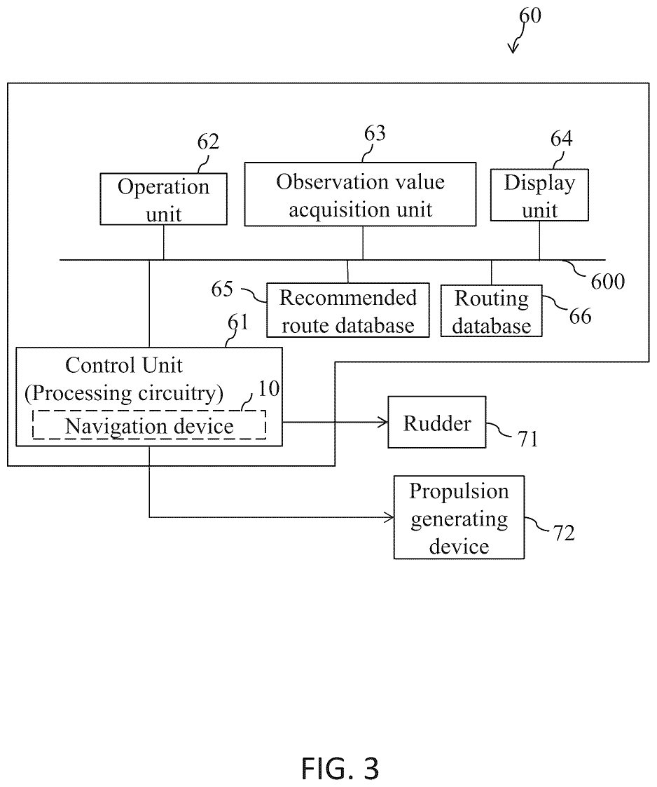

As shown in FIG. 1, the navigation device 10 includes an acquiring unit 20, an overlapping unit 30, a receiving unit 40, and a route generation unit 50. FIG. 2 is a block diagram of the route generation unit according to an embodiment of the present invention. The route generation unit 50 includes a determination unit 51 and a comparing unit 52. FIG. 3 is a functional block diagram of a navigation system according to an embodiment of the present invention. As shown in FIG. 3, the navigation system 60 includes a control unit (processing circuitry) 61, an operation unit 62, an observation value acquisition unit 63, a display unit 64, a recommended route database 65, and a routing database 66.

Referring to FIGS. 1-3, the acquiring unit 20 acquires a recommended route connecting two or more waypoints on a chart. In one embodiment, the recommended route is acquired from the recommended route database 65. In another embodiment, the recommended route is acquired based on an input from a user. In one embodiment, the recommended route is prepared at production-time and added to the recommended route database 65. In another embodiment, the recommended route is prepared during run-time based on the input from the user, and added to the recommended route database 65. The input from the user is received in real-time. The recommended route is added to the recommended route database 65 in real-time. Further, the acquiring unit 20 acquires the recommended route from the recommended route database 65.

In one embodiment, the recommended route is received based on the input from the user. Further, the recommended route may be stored in the recommended route database 65. The recommended route database comprises data associated with a plurality of recommended routes. In one example, the recommended route database may be stored in charts, and the like.

In one embodiment, the acquiring unit 20 acquires the plurality of recommended routes for a ship. Further, the acquiring unit 20 identifies the recommended route nearest to a start point of the ship. The navigation device 10 further uses the identified recommended route. In one embodiment, the start point of the ship indicates a current location of the ship. The current location of the ship is determined using at least one of a sensor, a Global Positioning System (GPS), and inputs from the user.

In one embodiment, a distance between two waypoint from the two or more waypoint of the recommended route is one of greater than, less than, and equal to a predetermined threshold. If the distance between the two waypoints is greater than the predetermined threshold, the acquiring unit 20 determines a midpoint between the two waypoints of the recommended route.

In one example, assume the distance between the two waypoints of the recommended route is 40 NM, and the predetermined threshold is 25NM. Here, the distance between the two waypoints is greater than the predetermined threshold. Hence, the midpoint associated with the recommended route is determined.

Further, the acquiring unit 20 acquires a routing database 66 (i.e., a mesh database). The routing database 66 comprises vertex data. In one embodiment, the routing database 66 comprises mesh data. In one example, the vertex data may be applied as the mesh data. The mesh data includes multiple nodes and multiple links connecting the multiple nodes on the chart. The nodes are associated with multiple points on the chart, and the links indicate multiple routes connecting the multiple points on the chart. In one embodiment, the mesh data and the vertex data are mutually convertible. Further, a center of a mesh is a vertex, and adjacent vertices are connected to each other.

Once the recommended route is acquired, the overlapping unit 30 combines data associated with the recommended route database (i.e., the recommended route database) 65 and the vertex data associated with the routing database 66. Further, the overlapping unit 30 generates an overlapped database comprising the recommended route overlapped on the vertex data. In one embodiment, the overlapped database comprises the overlapping of the recommended route on the vertex data. The overlapped database provides the nodes and links associated with the two or more waypoints of the recommended route.

Further, the receiving unit 40 receives the start point and an end point to generate an optimal route for the ship. The start point and end point are associated with the ship. The start point indicates the current location of the ship. The end point indicates a destination location of the ship. In one embodiment, the start point indicates a starting location coordinates associated with the ship, and the end point indicates a destination location coordinates associated with the ship. The start point of the ship is received using at least one of a sensor, the GPS, and the inputs from the user. The end point of the ship is received based on a user input. The user input may be received as one of a text input, a touch input, and the like.

Once the start point and the end point are received, the receiving unit 40 receives a route request for generating the optimal route for the ship. The route request indicates generation of the optimal route from the start point to the end point for the ship.

Furthermore, the route generation unit 50 generates the optimal route for the ship between the start point and the end point. In one embodiment, the route generation unit 50 utilizes a shortest path search technique to generate the optimal route for the ship. The shortest path search technique is one of a Dijkstra's technique, a bidirectional Dijkstra's technique, an A* technique, a bellman-ford technique, and an ant colony optimization technique. It will be understood to a person skilled in the art that in alternate embodiments, any suitable shortest path search technique apart from the aforementioned techniques may be utilized to generate the optimal route for the ship, without deviating from the scope of the present disclosure.

The route generation unit 50 generates a plurality of routes connecting the start point and the end point using a plurality of waypoints on the chart. Each route from the plurality of routes include at least one of a first subset of routes and a second subset of routes. The first subset of routes comprise at least a portion of the recommended route. The second subset of routes comprises routes excluding the recommended route. In one embodiment, the first subset of routes comprise combination of a portion of other routes excluding the recommended route and at least the portion of the recommended route. The first subset of routes may comprise the recommended route.

As shown in FIG. 2, the route generation unit 50 comprises a determination unit 51 and a comparison unit 52. In one embodiment, the determination unit 51 determines a cost associated with the plurality of routes and a cost associated with the recommended route. In one embodiment, the determination unit 51 determines the cost associated with each route from the plurality of routes. The cost of each route of the first subset of routes is determined by utilizing a first technique. The cost associated with each route of the second subset of routes is determined by utilizing a second technique.

In one embodiment, the first technique comprises a summation of a cost of the two or more waypoints associated with the recommended route. The second technique comprises a summation of a cost multiple waypoints excluding the waypoint associated with the recommended route. In one embodiment, the first technique includes an addition of the cost associated with the routes connected by the two or more waypoint of the recommended route. The second technique includes an addition of the cost associated with the routes connected by the multiple waypoint excluding the waypoints of the recommended route. The first technique is used to determine the cost of the recommended route, the second technique is used to determine the cost of the other routes excluding the recommended route. In one embodiment, the determination of the cost of the two or more waypoints of the recommended route is different from the determination of the cost of the multiple waypoints of the other routes excluding the recommended route.

In one embodiment, the determination unit 51 determines the cost between two waypoints in the recommended route based on multiplying a distance between the two waypoints by an arbitrary value less than one. The cost of the recommended route is determined based on multiplying the distance between the two waypoints of the recommended route by the arbitrary value less than one. In one embodiment, the arbitrary value less than one is predefined. In one embodiment, the first technique may comprise determination of the cost of the recommended route by multiplying the distance between the two waypoints of the recommended route by the arbitrary value less than one.

Further, the determination unit 51 determines the cost between two waypoints excluding the recommended route based on multiplying a distance between the two waypoints by an arbitrary value greater than one. The cost of the other routes excluding the recommended route is determined based on multiplying the distance between the two waypoint by the arbitrary value greater than one. In one embodiment, the arbitrary value greater than one is predefined. In one embodiment, the second technique may comprise determination of the cost of the recommended route by multiplying the distance between the two waypoints of the other route by the arbitrary value greater than one. In one embodiment, the cost of each route from the plurality of routes is determined using one of the first technique and the second technique.

Once the cost of each route is determined, the comparing unit 52 compares the cost of each route from the plurality of routes connecting the start point and the end point. In one embodiment, the cost of the two or more waypoints of the recommended route and the cost of the multiple waypoints of the other routes excluding the recommended route are compared. In another embodiment, the cost of each route from the first subset of routes and the second subset of routes connecting the start point and the end point is compared. Based on the comparison of the costs, the optimal route between the start point and the end point of the ship is generated.

In one embodiment, the determination unit 51 determines the cost of the recommended route using based on multiplying the distance between the waypoints of the recommended route by the arbitrary value less than one. Further, the determination unit 51 determines the cost of the other routes excluding the recommended route. The cost of the other routes correspond to the distance between the two waypoints of each of the other routes. Furthermore, the comparing unit 52 compares the cost of the first subset of routes and the cost of the other routes connecting the start point and the end point. Based on the comparison, the route generation unit 50 generates the optimal route for the ship.

In another embodiment, the determination unit 51 determines the cost of the routes excluding the recommended route based on multiplying the distance between two waypoints of each route from the other routes by the arbitrary value greater than one. Further, the determination unit 51 determines the cost of the recommended route. The cost of the recommended route corresponds to the distance between the two waypoints of the recommended route. Furthermore, the comparing unit 52 compares the cost of each route connecting the connecting the start point and the end point. Based on the comparison, the route generation unit 50 generates the optimal route for the ship.

Subsequently, the route generation unit 50 generates the optimal route based on the cost of the plurality of routes and the cost of the recommended route. In one embodiment, the optimal route is generated based on the comparison of the costs. The optimal route corresponds to a shortest distance route between the start point and the end point. The optimal route indicates a low cost route from the start point to the end point of the ship. In one embodiment, the cost of the recommended route is relatively less than the cost of the other routes from the plurality of routes.

Upon generation of the optimal route, the route generation unit 50 further applies a smoothing technique on the optimal route except the portion of the recommended route. In one embodiment, the smoothing technique is applied on the portion of the optimal route that connects the ends of the recommended route to the start point and the end point. The smoothing technique helps to make the optimal route smoother, thereby reducing the distance to be travelled.

Further, the display unit 64 displays the optimal route to the user. The optimal route is displayed on a user device associated with the user.

In this way, the navigation device 10 generates the optimal route for the ship. At this time, the navigation device 10 acquires the recommended route connecting the two or more waypoints on the chart. Further, the navigation device 10 receives the start point and the end point for generating the optimal route for the ship. Furthermore, the navigation device 10 generates the optimal route between the start point and the end point. The optimal route corresponds to the shortest distance route between the start point and the end point. Therefore, the navigation device 10 generates the optimal route for the ship. The optimal route may be referred as an optimized route for the ship.

### Configuration of the Navigation System 60

Referring to FIG. 3, the navigation system 60 is mounted on the ship performing, for example, an autopilot control (automatic navigation control).

The control unit 61 is connected to a rudder 71 and a propulsion generating unit 72. The rudder 71 and the propulsion generating unit 72 are mounted on a hull of the ship. The control unit 61, the rudder 71 and the propulsion generating unit 72 are connected, for example, via analog voltage or data communication.

The control unit 61, the operation unit 62, the observation value acquisition unit 63, the display unit 64, the recommended route database 65, and the routing database 66 are connected to each other by, for example, a data communication network 600 for ships.

The operation unit 62 is realized by, for example, a touch panel, physical buttons or switches. The operation unit 62 accepts the operation of settings related to the autopilot control.

The observation value acquisition unit 63, realized by various sensors, acquires state data indicating the state of the ship such as its own position, the end point, the heading, a ship speed, a response angular speed, and a rudder angle.

The display unit 64, for example, is realized by a liquid crystal panel or the like. When information or the like related to the autopilot control is input from the control unit 61, for example, the display unit 64 displays the information i.e., the optimal route between the start point and the end point of the ship. In one embodiment, the display unit 64 displays the optimal route for the ship, the recommended route for the ship, and the like. Although it is possible to omit the display unit 64, it is preferable to have it, and the presence of the display unit 64 allows the user to easily grasp the autopilot control status, etc.

The control unit 61 generates and stores the route information of the ship as described above. That is, the control unit 61 includes the configuration of the navigation device 10 described above.

The control unit 61 performs autopilot control by a known method based on the operation input from the operation unit 62 and the state data from the observation value acquisition unit 63. The control unit 61 controls the steering angle of the rudder 71 and the propulsive force of the propulsion generating unit 72 by the autopilot control.

In one embodiment, the control unit 61 acquires the recommended route connecting the two or more waypoints on the chart. Further, the control unit 61 receives the start point and the end point to generate the optimal route for the ship. The control unit 61 further generates the optimal route between the start point and the end point. The control unit 61 performs rudder angle control and propulsion control based on the distances and directions, as well as the current ship speed, bow direction, motion characteristics of the ship, pier position and pier position.

In this case, the control unit 61 may display the optimal route on the display unit 64.

With this, the navigation system 60 may assist the ship in finding the optimal route between the start point and the end point.

### Examples of Specific Configurations of Navigation Device 10

Further, a specific configuration example of the navigation device 10 will be described. In the following, the case of generation of the optimal route using the A* technique will be described. It should be noted that any suitable shortest path search technique apart from the aforementioned technique may be utilized to generate the optimal route for the ship.

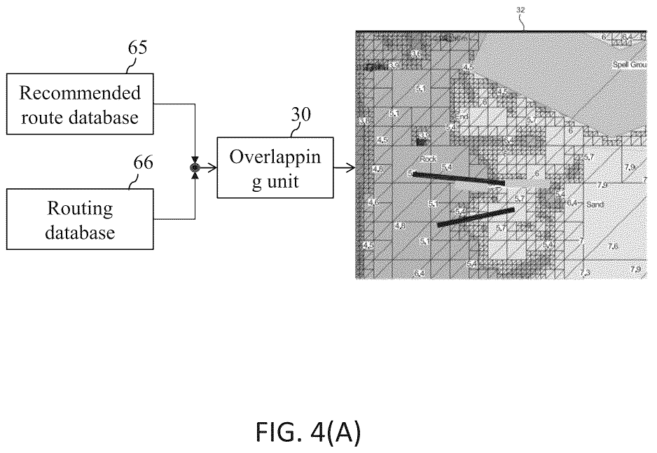

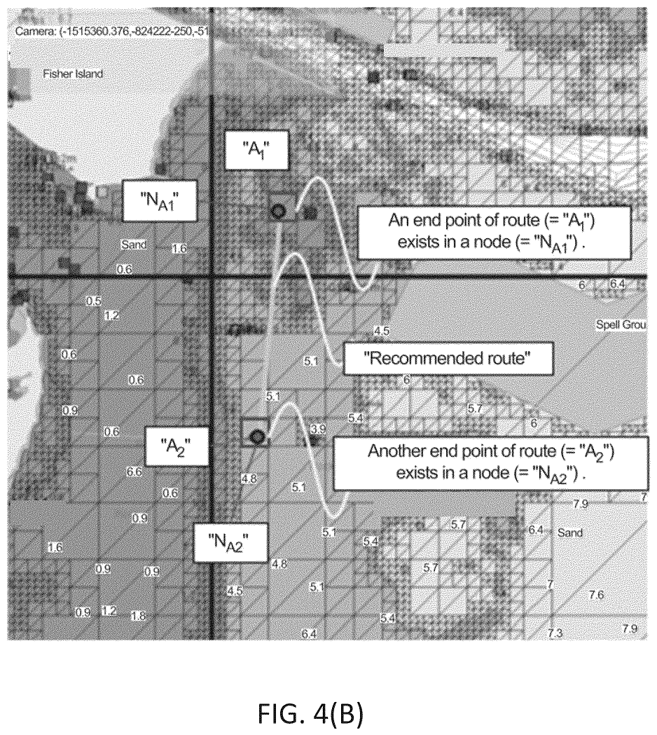

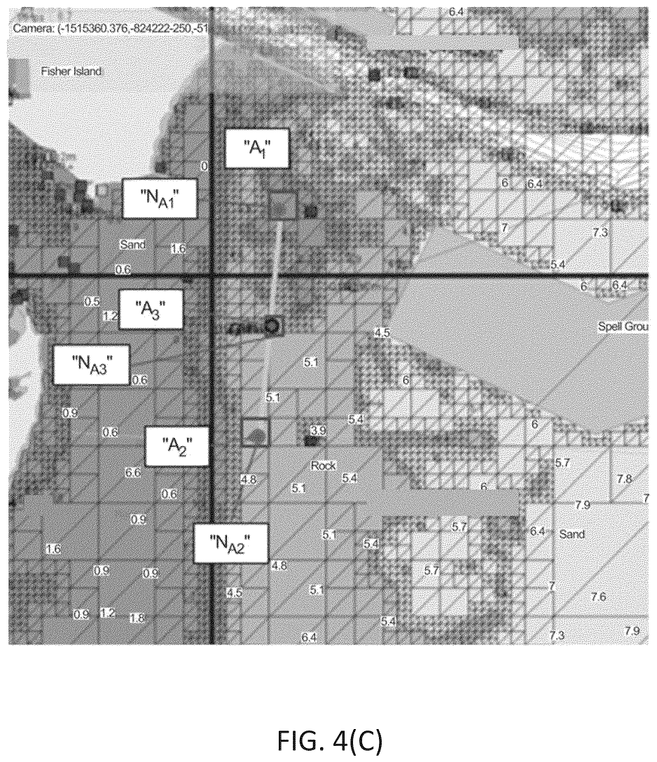

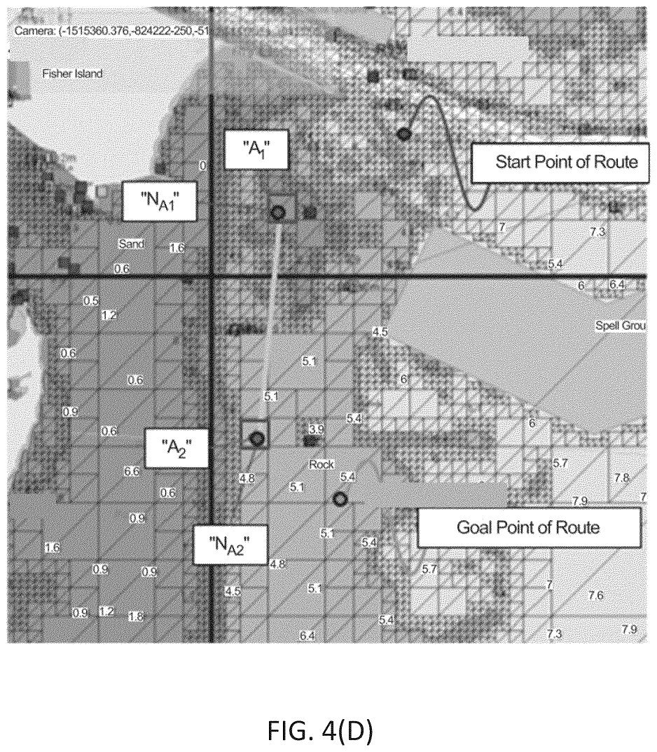

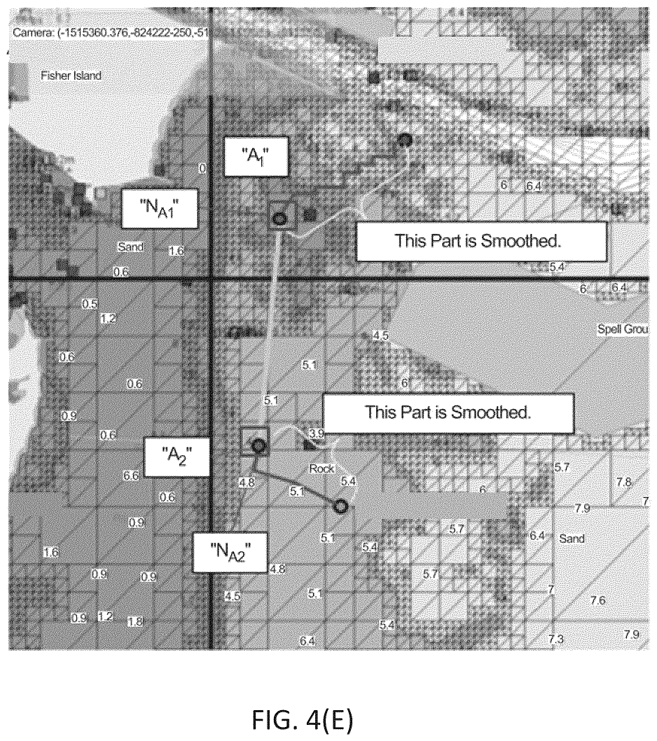

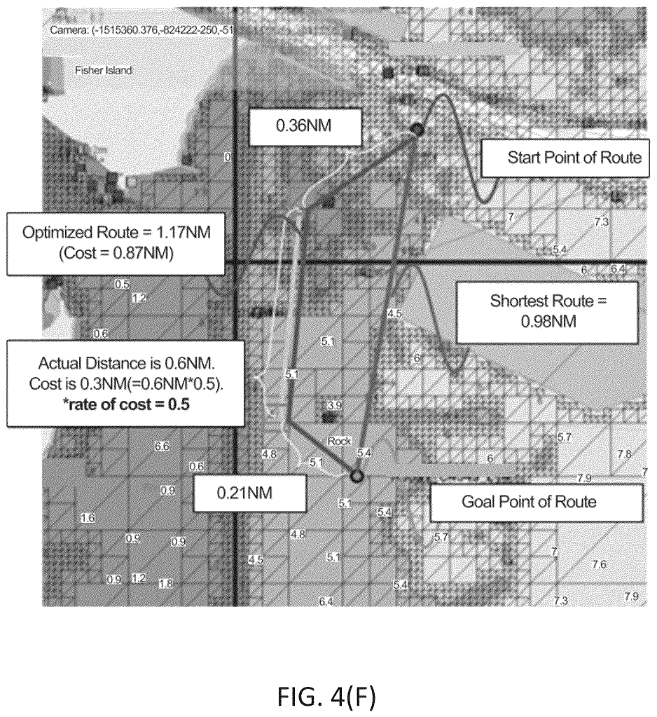

FIG. 4(A) is a block diagram of the overlapping unit 30 according to an embodiment of the present invention. In one embodiment, the overlapping unit 30 receives the data from the recommended route database 65 and the vertex data from the routing database 66. The data of the recommended route database 65 comprises the plurality of recommended routes. In one embodiment, the recommended route is added to the recommended route database 65 at the production time. In another embodiment, the recommended route is added to the recommended route database 65 based on the user input at the run-time. The user input related to the recommended route is received from the user in real-time. Further, the vertex data of the routing database 66 comprises the multiple nodes and the multiple links connecting the multiple nodes. Each node from the multiple nodes indicates a point on the chart. Each link from the multiple links indicate a route connecting two nodes on the chart.

In one embodiment, the overlapping unit 30 overlaps the data from the recommended route database 65 and the vertex data. The data from the recommended route database 65 and the vertex data are combined during run-time. Upon overlapping, the overlapping unit 30 generates the overlapped database 32. The overlapped database 32 comprises overlapped data. The overlapped data indicates the nodes associated with the recommended route and the link associated with the recommended route.

FIG. 4(B) is the overlapped database according to an embodiment of the present invention. In one embodiment, the recommended route is acquired from the recommended route database 65. Further the data from the recommended route database 65 and the vertex data are combined to generate the overlapped database 32. The overlapped database 32 shows the nodes associated with each point of the recommended route. In one embodiment, A1 and A2 are the waypoints associated with the recommended route. Further, the node NA1 associated with the point A1, and the node NA2 associated with the point A2 are identified on the chart using the overlapped database. The link connecting A1 having node NA1 and A2 having the node NA2 is the recommended route.

Further, the links connecting “A1”, “A2”, “NA1” and “NA2” are added to a “Link list of Recommended route”. The link list of the recommended route comprises suggested routes. The suggested routes comprise links such as {“NA1”, “A1”}, {“A1”, “A2”}, {“A2”, “NA2”}, {“NA2”, “A2”}, {“A2”, “A1”}, and {“A1”, “NA1”}. The links may be traversed in both directions i.e., forward and reverse.

FIG. 4(C) shows determination of a midpoint on the recommended route according to an embodiment of the present invention. In one embodiment, the midpoint between the two waypoints of the recommended route is determined, when the distance between the two waypoints is greater than the predetermined threshold. As shown in FIG. 4(C), A1 and A2 are the waypoints associated with the recommended route. Further, NA1 is the node associated with A1, and NA2 is the node associated with A2. Further, the route generation unit 50 determines the distance between the two waypoints A1 and A2. If the distance between A1 and A2 is greater than the predetermined threshold, then the midpoint between A1 and A2 is determined. The midpoint is referred as point A3. Further, the node NA3 associated with the point A3 is identified on the chart using the overlapped data of the overlapped database 32.

FIG. 4(D) shows the receiving of the start point and the end point according to an embodiment of the present invention. In one embodiment, the start point and the end point of the ship is received to generate the optimal route. The start point indicates the current location of the ship, and the end point (i.e., a goal point) indicates the destination point of the ship. In one embodiment, the start point is determined by a sensor or the GPS. In another embodiment, the start point is received based on inputs from the user. The end point is received based on the user input. The user input may be a touch input (i.e., touch at a point on the chart), a text input, and the like.

Upon receiving the start point and the end point, a node is popped from OpenList*. Further, a link between the mesh of nodes is checked. Furthermore, the nodes are checked if they belongs to “; Link list of Recommended route”;, for example, the link{“NA1”, “A1”} is checked. The link list of recommended route comprises the links such as {“NA1”, “A1”}, {“A1”, “; A2”}, {“A2”, “NA2”}, {“NA2”, “A2”}, {“A2”, “A1”}, and {“A1”, “NA1”}.

Further, the cost between two waypoints in the recommended route is determined based on multiplying a distance between the two waypoints by an arbitrary value less than 1.

In one example, the node “N_{A1}” is popped from OpenList. Further, a distance of center of “N_{A1}”->“A₁” is calculated. Furthermore, a Parent* of “A₁” is recorded with “N_{A1}”, and “A₁” is added to the OpenList. In another example, if the “A₁” is popped from the OpenList. Further, a distance of “A₁”->“A₂” is calculated. Furthermore, a Parent* of “A₂” is recorded with “A₁”, and “A₂” is added to the OpenList. The actual distance between “A₁” and “A₂” is 0.6NM. Further, the cost of the recommended route is determined by multiplying the distance=0.6NM with the arbitrary value 0.5. The cost of the route connecting A1 and A2 is 0.3NM (=0.6 NM*0.5) .

Furthermore, the cost of the other routes excluding the recommended route is determined. The cost of the recommended route and the cost of the other routes is compared. Based on the comparison, the optimal route for the ship is generated. The optimal route is the lowest cost route between the start point and the end point of the ship.

FIG. 4(E) shows applying smoothing on the optimal route according to an embodiment of the present invention. In one embodiment, once the optimal route is generated, the smoothing technique is applied on a portion of the optimal route excluding the recommended route. In one aspect, the smoothing technique is not applied on the recommend route. In one example, the route i.e., the start point ->A1->A2-> the end point, is generated as the optimal route. Further, A1 and A2 are the waypoint of the recommended route. Furthermore, the route after the ends of the recommended route i.e., A1 and A2 till the start point and the end point is smoothed. In one embodiment, the smoothing technique is applied on the portion of the optimal route i.e., the start point ->A1 and A2->the end point.

FIG. 4(F) shows an example of generation of the optimal route according to an embodiment of the present invention. As shown in FIG. 4(F), the route between the start point and the end point is a straight line having the distance and the cost as 0.98NM. Further, the navigation device 10 generates the optimal route between the start point and the end point of the ship. The optimal route, i.e., the start point->A₁->A₂-> the end point (i.e., the goal point), is having the actual distance as 1.17NM. The optimal route is the combination of the recommended route i.e., A1->A2, and the routes i.e., the start point->A1 and A2-> the end point. The cost of the route i.e., the start point->A1, is 0.36NM, and the cost of the route i.e., A2-> the end point, is 0.21NM. Further, the cost of the recommended route i.e., A1->A2, is determined as the multiplication of the distance between A1 and A2 i.e., 0.6NM, and the arbitrary value i.e., 0.5. The cost of the recommended route is 0.3NM (i.e., 0.6NM*0.5 ). Here, the cost of the route i.e., the start point->A₁->A₂-> the end point, is 0.87NM. Here, the cost of the route i.e., the start point->A₁->A₂-> the end point, is less than the cost of the route connecting the start point and the end point using the straight line. Hence, the route i.e., the start point->A₁->;A₂-> the end point is the optimal route. The optimal route having the lowest cost is generated.

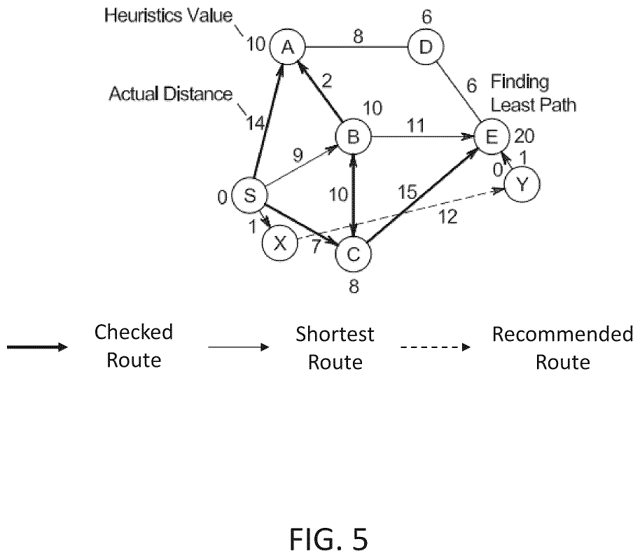

FIG. 5 shows a graph used for generation of the optimal route according to an embodiment of the present invention. In one embodiment, a route connecting the points X and Y is the recommended route. Further, the graph comprising the waypoints {A,B,C,D,S,E} is generated. In one example, the waypoints {A,B,C,D,S,E} are nearest to the waypoints X and Y. The start point S and the end point E (i.e., the goal point) are received.

In one example, the A* technique is used for generating the optimal route. The points S and E are identified as nearest points to the waypoints X and Y of the recommended route. The connection between S and E through the recommended route i.e., points X and Y is established. Subsequently, the plurality of routes connecting the point S and E via different waypoints are generated. The plurality of routes comprises the routes having the portion of the recommended route and the routes excluding the recommended route. The plurality of routes comprises the routes such as [S,B,E], [S, C, E], and the like. The actual distance between the two way points is determined.

The distance indicates the cost of the route connecting two waypoints. Further, a heuristic value is assigned to each waypoint i.e., A, B, C, D, S, and E in terms of whether the waypoint approaches the end point E. The sum of the costs of the route, and the heuristic value is calculated for each route. Further, the route having the lowest cost is adopted as the optimal route. The optimal route is searched to take the recommended route preferentially because the recommended route from point X to point Y is set to be relatively low cost. In this case, the route [S,X,Y,E] is the cheapest cost route, hence, the route [S,X,Y,E] is used as the preferred route, instead of [S,B,E].

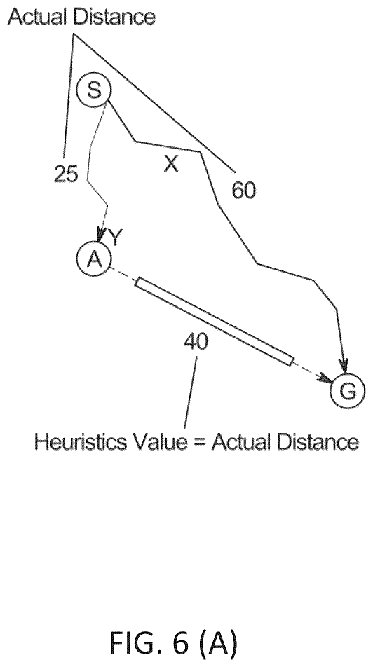

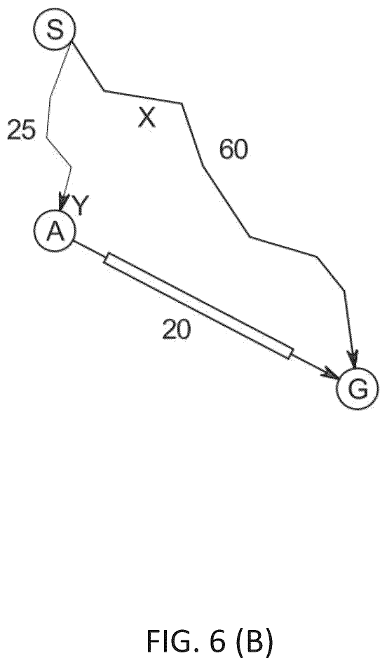

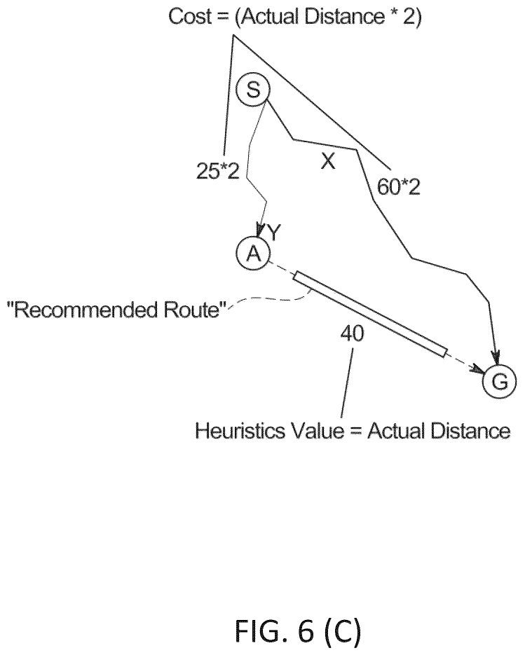

FIG. 6(A), FIG. 6(B), and FIG. 6(C) shows determination of cost of each route according to an embodiment of the present invention. In one embodiment, a route connecting point S and point G may be referred as a route X. Further, a route from the point A to the point G may be the recommended route. The route S->A->G may be referred as a route Y. In one embodiment, the distance between the point S and point G using the route X may be 60. The distance between the point S and the point A may be 25. The distance between the point A and the point G may be 40. Further, the cost of each route i.e., the route X and the route Y may be determined to generate the optimal route.

As shown in FIG. 6(A), the cost of the route X and the route Y may be determined using equation 1 and equation 2 given below.

$$Cost of X = 60 ( Fixed Cost = 60 , Heuristics = 0 ) \qquad ( 1 )$$

$$Cost of Y = 65 ( Fixed Cost = 25 , Heuristics = 40 ) \qquad ( 2 )$$

In this case, the cost of the route X is 60 and the cost of the route Y is 65. The cost of the route X is less than the cost of the route Y.

As shown in FIG. 6(B), the cost of the route X and the route Y may be determined using equation 3 and equation 4 given below. The cost of the recommended route i.e., from the point A to the point G may be determined by multiplying the distance i.e., 40 by the arbitrary value less than one (for example 0.5). Hence, the cost of the recommended route may be 20 (i.e., 40*0.5). Further, the cost of the recommended route i.e., 20 may be used to determine the cost of the route Y. The method of generating the cost of the recommended route may be referred as the first technique.

$$Cost of X = 60 ( Fixed Cost = 60 , Heuristics = 0 ) \qquad ( 3 )$$

$$Cost of Y = 45 ( Fixed Cost = 25 + 20 , Heuristics = 0 ) \qquad ( 4 )$$

In this case, the cost of the route X is 60 and the cost of the route Y is 45. Hence, the cost of the route Y may be the low cost route. Thus, the route Y may be referred as the optimal route. The route Y may comprise the recommended route and the other route i.e., the route S->A.

As shown in FIG. 6(C), the cost of the route X and the cost of the route Y may be determined using the equation 5 and the equation 6 given below. Here, the cost of the routes excluding the recommended route may be determined by multiplying the distance by the arbitrary value greater than one (for example, 2). The cost of the route S->A may be determined by multiplying distance between the points S and A by 2. Hence the cost of the route S->A may be 50 (i.e., 25*2). Further, the cost of the route S->G i.e., the route X, may be determined by multiplying distance between the points S and A by 2. Hence the cost of the route X may be 120 (i.e., 60*2). The method of generating the cost of the routes other than the recommended route may be referred as the second technique.

$$Cost of X = 120 ( Fixed Cost = 60 * 2 , Heuristics = 0 ) \qquad ( 5 )$$

$$Cost of Y = 90 ( Fixed Cost = 25 * 2 , Heuristics = 40 ) \qquad ( 6 )$$

In this case, the cost of the route X is 120 and the cost of the route Y is 90. Hence, the cost of the route Y may be the low cost route. Thus, the route Y may be referred as the optimal route. The route Y may comprise the recommended route and the other route i.e., the route S->A.

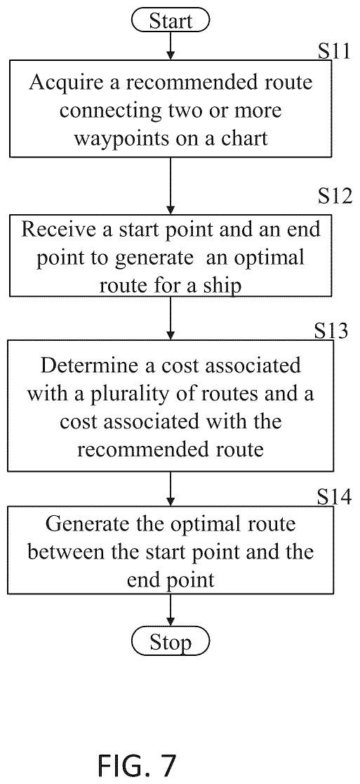

In one embodiment, the navigation device 10 utilizes the techniques as shown in FIG. 6(B) and FIG. 6(C) to generate the final optimal route for the ship from the start point to the end point. In one embodiment, the navigation device 10 generates the optimal route using FIG. 6(B), and again the optimal route is generated using the FIG. 6(C). Finally, the navigation device 10 generate the finalized optimal route for the ship. In one embodiment, the cost of the recommended route is relatively less than the cost of the other routes from the plurality of routes. Thus, the recommended route may be selected and finalized as the optimal route from the start point to the end point. (Navigation device) FIG. 7 is a flow chart showing an example of the navigation device according to an embodiment of the present invention.

It should be noted that the specific details of each process in the flow chart shown in FIG. 7 have been described with the explanation of the configuration described above, so explanation will be omitted below except where necessary.

The navigation device 10 acquires the recommended route connecting the two or more waypoints on the chart (S11). Further, the navigation device 10 receives the start point and the end point to generate the optimal route for the ship (S12).

Furthermore, the navigation device 10 determines a cost associated with a plurality of routes and a cost associated with the recommended route (S13). The cost associated with the recommended route is relatively less than the cost associated with other routes from the plurality of routes.

Furthermore, the navigation device 10 generates the optimal route between the start point and the end point (S14). The optimal route is generated based on the cost associated with the plurality of routes and the cost associated with the recommended route.

### Terminology

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

All processes described herein may be embodied in, and fully automated via, software code modules executed by a computing system that includes one or more computers or processors. The software code modules may be stored in any type of non-transitory computer-readable medium or other computer storage device. Some or all methods may be embodied in specialized computer hardware.

Many other variations other than those described herein will be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes can be performed by different machines and/or computing systems that can work together.

The various exemplary logical blocks and modules described in connection with the embodiments disclosed herein can be implemented or executed by a machine such as a processor. The processor may be a microprocessor, but alternatively, the processor may be a controller, a microcontroller, or a state machine, or a combination thereof. The processor can include an electrical circuit configured to process computer executable instructions. In another embodiment, the processor includes an application specific integrated circuit (ASIC), a field programmable gate array (FPGA), or other programmable device that performs logical operations without processing computer executable instructions. The processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processor may also include primarily analog components. For example, some or all of the signal processing algorithms described herein may be implemented by analog circuitry or mixed analog and digital circuitry. A computing environment may include any type of computer system, including, but not limited to, a computer system that is based on a microprocessor, mainframe computer, a digital signal processor, a portable computing device, a device controller, or a computing engine within the device.

Unless otherwise stated, conditional languages such as “can,” “could,” “will,” “might,” or “;may” are understood within the context as used in general to convey that certain embodiments include, while other embodiments do not include, certain features, elements and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive languages, such as the phrase “at least one of X, Y, or Z,” unless specifically stated otherwise, is understood with the context as used in general to present that an item, term, etc., may be either X, Y, or Z, or any combination thereof (e.g., X, Y, and/or Z). Thus, such a disjunctive language is not generally intended to, and should not, imply that certain embodiments require at least one of X, at least one of Y, or at least one of Z to each be present.

Any process descriptions, elements, or blocks in the flow diagrams described herein and/or shown in the accompanying drawings should be understood as potentially representing modules, segments, or parts of code, including one or more executable instructions for implementing a particular logical function or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “; a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “;upper,” “over,” and “under” are defined with respect to the horizontal plane.

As used herein, the terms “attached,” “connected,” “coupled,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially”; as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation device to be mounted on a ship, the navigation device comprising:
processing circuitry configured to:
acquire a recommended route connecting two or more waypoints on a chart;
receive a start point and an end point to generate an optimal route for the ship;
determine a cost associated with a plurality of routes and a cost associated with the recommended route, wherein the cost associated with the recommended route is relatively less than the cost associated with other routes from the plurality of routes; and
generate the optimal route between the start point and the end point based on the cost associated with the plurality of routes and the cost associated with the recommended route.

2. The navigation device according to claim 1, wherein the optimal route is generated using a shortest path search technique.

3. The navigation device according to claim 2, wherein the shortest path search technique is one of a Dijkstra's technique, a bidirectional Dijkstra's technique, an A* technique, a Bellman-ford technique, and an ant colony optimization technique.

4. The navigation device according to claim 1, wherein the processing circuitry is further configured to:
generate the plurality of routes connecting the start point and the end point using a plurality of waypoints on the chart, and wherein each route from the plurality of routes includes at least one of a first subset of routes and a second subset of routes, and wherein the first subset of routes comprise at least a portion of the recommended route and the second subset of routes comprises routes excluding the recommended route.

5. The navigation device according to claim 4, wherein the processing circuitry is further configured to:
determine the cost associated with each route of the first subset of routes by utilizing a first technique and the cost associated with each route of the second subset of routes by utilizing a second technique.

6. The navigation device according to claim 5, wherein the first technique comprises a summation of a cost of the two or more waypoints associated with the recommended route, and wherein the second technique comprises a summation of a cost of multiple waypoints excluding the recommended route.

7. The navigation device according to claim 1, wherein the processing circuitry is further configured to:
determine the cost between two waypoints in the recommended route based on multiplying a distance between the two waypoints by an arbitrary value less than one.

8. The navigation device according to claim 1, wherein the processing circuitry is further configured to:
determine the cost between two waypoints excluding the recommended route based on multiplying a distance between the two waypoints by an arbitrary value greater than one.

9. The navigation device according to claim 1, wherein the processing circuitry is further configured to:
compare the cost of each route from the plurality of routes connecting the start point and the end point, wherein the optimal route is generated based on the comparison of the cost of each route.

10. The navigation device according to claim 1, wherein the processing circuitry is further configured to:
apply a smoothing technique on the optimal route except the portion of the recommended route.

11. The navigation device according to claim 1, wherein the processing circuitry is further configured to:
determine a midpoint between the two waypoints of the recommended route, when the distance between the two waypoints is greater than a predetermined threshold.

12. The navigation device according to claim 1, wherein the recommended route is acquired from one of a recommended route database or an input from a user.

13. The navigation device according to claim 12, wherein the processing circuitry is further configured to:
combine data associated with the recommended route database and vertex data associated with a routing database to generate an overlapped database comprising the recommended route overlapped on the vertex data.

14. The navigation device according to claim 1, further comprises:
a display configured to display the optimal route to the user.

15. The navigation device according to claim 1, wherein the start point corresponds to a current location of the ship and the end point is received based on a user input.

16. The navigation device according to claim 3, wherein the processing circuitry is further configured to:
generate the plurality of routes connecting the start point and the end point using a plurality of waypoints on the chart, and wherein each route from the plurality of routes includes at least one of a first subset of routes and a second subset of routes, and wherein the first subset of routes comprise at least a portion of the recommended route and the second subset of routes comprises routes excluding the recommended route.

17. The navigation device according to claim 16, wherein the processing circuitry is further configured to:
determine the cost associated with each route of the first subset of routes by utilizing a first technique and the cost associated with each route of the second subset of routes by utilizing a second technique.

18. The navigation device according to claim 17, wherein first technique comprises a summation of a cost of the two or more waypoints associated with the recommended route, and wherein the second technique comprises a summation of a cost of multiple waypoints excluding the recommended route.

19. A navigation method comprising:
acquiring a recommended route connecting two or more waypoints on a chart;
receiving a start point and an end point to generate an optimal route for a ship;
determining a cost associated with a plurality of routes and a cost associated with the recommended route, wherein the cost associated with the recommended route is relatively less than the cost associated with other routes from the plurality of routes; and
generating the optimal route between the start point and the end point based on the cost associated with the plurality of routes and the cost associated with the recommended route.

20. A non-transitory computer-readable medium having stored thereon computer-executable instructions which, when executed by a computer, cause the computer to:
acquire a recommended route connecting two or more waypoints on a chart;
receive a start point and an end point to generate an optimal route for a ship;
determine a cost associated with a plurality of routes and a cost associated with the recommended route, wherein the cost associated with the recommended route is relatively less than the cost associated with other routes from the plurality of routes; and
generate the optimal route between the start point and the end point based on the cost associated with the plurality of routes and the cost associated with the recommended route.
